(19) United States
(12) Patent Application Publication
(10) Pub. No.: US 2024/0404153 A1
(43) Pub. Date: Dec. 5, 2024

(54) PICTURE RENDERING METHOD AND APPARATUS, DEVICE, STORAGE MEDIUM, AND PROGRAM PRODUCT

(71) Applicant: Tencent Technology (Shenzhen) Company Limited, Shenzhen (CN)

(72) Inventor: Shili XU, Shenzhen (CN)

(21) Appl. No.: 18/803,320

(22) Filed: Aug. 13, 2024

Related U.S. Application Data
(63) Continuation of application No. PCT/CN2023/130354, filed on Nov. 8, 2023.

(30) Foreign Application Priority Data
Nov. 30, 2022 (CN) 202211522911.1

(51) Int. Cl. G06T 11/60; A63F 13/52

(52) U.S. Cl. CPC G06T 11/60; A63F 13/52; G06T 2200/24; G06T 2210/62

(57) ABSTRACT

This application discloses a picture rendering method performed by a computer device. The method includes: determining object changed content of a first rendering object from an i^{th} frame of interaction picture to an (i+1)^{th} frame of interaction picture in response to an interaction instruction by a user of the computer device; rendering, based on the object changed content, a first object layer corresponding to the first rendering object); and performing overlaying processing on the first object layer and a second object layer, to obtain the (i+1)^{th} frame of interaction picture, the second object layer being an object layer corresponding to a second rendering object that is not changed between the (i+1)^{th} frame of interaction picture and the i^{th} frame of interaction picture.

### CROSS-REFERENCE TO RELATED APPLICATIONS

This application is a continuation application of PCT Patent Application No. PCT/CN2023/130354, entitled “PICTURE RENDERING METHOD AND APPARATUS, DEVICE, STORAGE MEDIUM, AND PROGRAM PRODUCT” filed on Nov. 8, 2023, which claims priority to Chinese Patent Application No. 202211522911.1, entitled “PICTURE RENDERING METHOD AND APPARATUS, DEVICE, STORAGE MEDIUM, AND PROGRAM PRODUCT” filed on Nov. 30, 2022, both of which are incorporated herein by reference in their entirety.

### FIELD OF THE TECHNOLOGY

Embodiments of this application relate to the field of computer technologies, and in particular, to a picture rendering method and apparatus, a device, a storage medium, and a program product.

### BACKGROUND OF THE DISCLOSURE

Displaying a picture displayed when an application is running at a higher frame rate can bring better user experience. Therefore, a user usually uses the application in a high frame rate mode.

Generally, in the related art, to keep the application continuously running in the high frame rate mode, hardware performance is improved to improve a frame rate in a running process of the application, or image quality of the application is reduced to reduce hardware performance required for the application to run in the high frame rate mode. In this way, a rendering speed is improved and a higher frame rate is supported.

However, the manner of improving the hardware performance to improve the frame rate is prone to severe hardware heating, and long-time running leads to a decrease in the hardware performance. The manner of reducing the image quality to improve the frame rate affects picture displaying of the application, and an image quality requirement of the user cannot be met. In other words, when the application is running in a high frame rate and high image quality mode, performance consumption of the application is high, and it is not possible to ensure that the application runs in the high frame rate and high image quality mode for long time.

### SUMMARY

Embodiments of this application provide a picture rendering method and apparatus, a device, a storage medium, and a program product, to reduce rendering pressure and improve picture rendering efficiency. In this way, long-time running of an application in a high image quality and high frame rate mode is supported. The technical solutions are as follows.

According to an aspect, an embodiment of this application provides a picture rendering method performed by a computer device, the method including:
determining object changed content of a first rendering object from an i^{th}frame of interaction picture to an (i+1)^{th}frame of interaction picture in response to an interaction instruction by a user of the computer device;
rendering, based on the object changed content, a first object layer corresponding to the first rendering object; and
performing overlaying processing on the first object layer and a second object layer, to obtain the (i+1)^{th}frame of interaction picture, the second object layer being an object layer corresponding to a second rendering object that is not changed between the (i+1)^{th}frame of interaction picture and the i^{th}frame of interaction picture.

According to another aspect, an embodiment of this application provides a computer device. The computer device includes a processor and a memory. The memory stores at least one instruction, at least one program, and a code set or an instruction set. The at least one instruction, the at least one program, and the code set or the instruction set are loaded and executed by the processor and cause the computer device to implement the picture rendering method according to the foregoing aspect.

According to another aspect, a non-transitory computer-readable storage medium stores at least one instruction, at least one program, and a code set or an instruction set. The at least one instruction, the at least one program, and the code set or the instruction set are loaded and executed by a processor of a computer device and cause the computer device to implement the picture rendering method according to the foregoing aspect.

Technical solutions provided in embodiments of this application have at least the following beneficial effects:

In the embodiments of this application, layer division is performed on a rendering object in an interaction process, to obtain an object layer corresponding to the rendering object. In an interaction process of an application, a computer device may determine in advance, according to a captured interaction instruction, a first rendering object that is changed in a next frame of picture waiting to be displayed compared with a current frame of picture, so that an object layer corresponding to the first rendering object is rendered independently. For a second object layer corresponding to a second rendering object that is not changed in a next frame, an object layer that has been rendered in the history may be reused. Finally, the next frame of picture is obtained in a manner of performing layer overlaying on a first object layer and the second object layer, so that rendering of the next frame of picture is completed. In this manner, because the second object layer that has been rendered before is reused when the next frame of picture is rendered, and there is no need to perform rendering again, when image quality of the application is unchanged, performance consumption of rendering a single frame of picture may be reduced, and rendering duration may be shortened, so that the application can be supported to run for long time in a high image quality and high frame rate mode. This helps improve picture smoothness of the application.

### BRIEF DESCRIPTION OF THE DRAWINGS

FIG. 1 is a schematic diagram of an implementation environment according to an exemplary embodiment of this application.

FIG. 2 is a flowchart of a picture rendering method according to an exemplary embodiment of this application.

FIG. 3 is a schematic diagram of layers in a picture rendering process according to an exemplary embodiment of this application.

FIG. 4 is a flowchart of a picture rendering method according to another exemplary embodiment of this application.

FIG. 5 is a flowchart of determining a layer rendering manner according to an exemplary embodiment of this application.

FIG. 6 is a flowchart of a picture rendering method according to another exemplary embodiment of this application.

FIG. 7 is a schematic diagram of layers in adjusting a layer display order according to another exemplary embodiment of this application.

FIG. 8 is a flowchart of a picture rendering method according to another exemplary embodiment of this application.

FIG. 9 is a block diagram of a structure of a picture rendering apparatus according to an exemplary embodiment of this application.

FIG. 10 is a block diagram of a structure of a computer device according to an exemplary embodiment of this application.

### DESCRIPTION OF EMBODIMENTS

First, terms described in embodiments of this application are introduced.

Virtual environment: The virtual environment is a virtual environment displayed (or provided) when an application runs on a computer device. The virtual environment may be a simulated environment of the real world, may be a semi-simulated and semi-fictional environment, or may be an entirely fictional environment. The virtual environment may be any one of a two-dimensional virtual environment, a 2.5-dimensional virtual environment, and a three-dimensional virtual environment. This is not limited in the embodiments of this application.

Virtual character: The virtual character is a movable object in the virtual environment. The movable object may be a virtual person, a virtual animal, a cartoon person, or the like, for example, a person displayed in the three-dimensional virtual environment. In some embodiments, the virtual character is a three-dimensional model created based on an animation skeleton technology. Each virtual character has a shape and a volume in the three-dimensional virtual environment, and occupies a part of space of the three-dimensional virtual environment.

User interface (UI) control: The user interface control is any visual control or element that can be seen on a user interface of the application, for example, a picture, an input box, a text box, a button, a label, or another control. Some UI controls respond to an operation of a user.

When the application is run in a high frame rate mode, the application has higher fluency and higher response efficiency to the operation of the user, and user experience is better. Currently, in the related art, a higher frame rate may be provided in a hardware-side or software-side optimization manner.

In hardware, hardware performance may be improved to enable the application to run in the high frame rate mode. However, long-time high-frame-rate running leads to a long-time heating problem and performance degradation, and may lead to occurrence of a frame loss problem. In software, currently, rendering workloads are reduced by reducing image quality of the application, to support a higher frame rate. However, the manner of reducing the image quality may not meet a requirement of the user for image quality, and the image quality and the frame rate cannot be compromised. In other words, when the application is running in a high frame rate and high image quality mode, performance consumption of the application is high, and it is not possible to ensure that the application runs in the high frame rate and high image quality mode for long time.

Therefore, in the embodiments of this application, a picture rendering method is provided. This can reduce consumption of rendering a single frame of picture without reducing image quality of an application. In this way, rendering pressure is reduced, performance consumption does not need to be increased, and the application can be supported to run in a high image quality and high frame rate mode for long time.

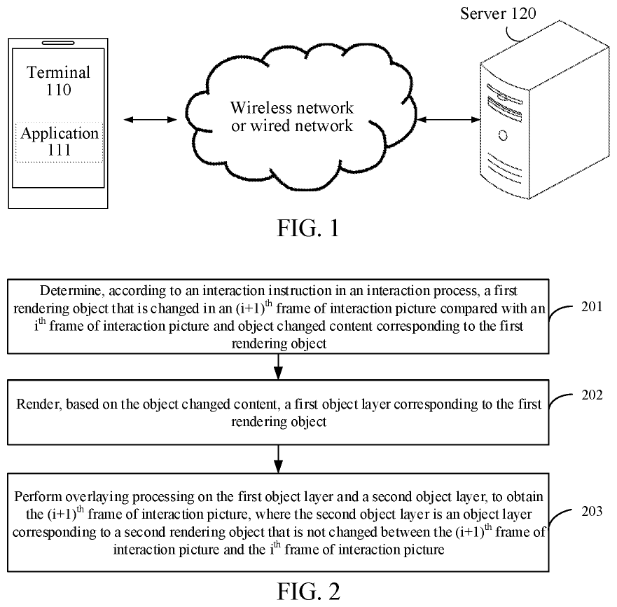

FIG. 1 is a schematic diagram of an implementation environment according to an embodiment of this application. The implementation environment may include a terminal 110 and a server 120.

An application 111 runs on the terminal 110. In some embodiments, the application 111 includes an instant messaging application, a video application, a social application, a financial application, an online shopping application, a music application, a food delivery application, an office application, a game application, a map application, a transportation application, a navigation application, and the like. When the application 111 runs on the terminal 110, a user interface (picture) of the application 111 is displayed on a screen of the terminal 110. In some embodiments, the terminal 110 may be at least one of a smartphone, a tablet computer, an e-book reader, a laptop portable computer, and a desktopcomputer.

Only one terminal is shown in FIG. 1, but a plurality of other terminals that can access the server 120 exist in another embodiment. Different terminals may be terminals used by different users. In some embodiments, a user operates in the application 111 via a display screen of the terminal 110, a physical key, a motion detection component in the terminal 110, an external device of the terminal 110, or the like, to affect a displayed picture of the application 111.

The terminal 110 and the other terminals are connected to the server 120 over a wireless network or a wired network.

The server 120 includes at least one of a server, a server cluster including a plurality of servers, a cloud computing platform, and a virtualization center. The server 120 is configured to provide a back-end service for the application 111. In some embodiments, the server 120 is responsible for primary computing work, and the terminal is responsible for secondary computing work. Alternatively, the server 120 is responsible for secondary computing work, and the terminal is responsible for primary computing work. Alternatively, a distributed computing architecture is used between the server 120 and the terminal to perform collaborative computing.

In a possible implementation, the server 120 may capture an interaction instruction delivered by the terminal 110 and a system (the server 120) in a running process of the application 111, determine, according to the interaction instruction, a first rendering object that is changed in a next frame of picture of the application 111 and object changed content corresponding to the first rendering object, render, based on the object changed content, a first object layer corresponding to the first rendering object, finally perform overlaying processing on the first object layer and a second object layer corresponding to a second rendering object that is not changed, to obtain the next frame of picture, and send the next frame of picture to the terminal 110 for display by the terminal 110.

Alternatively, in another possible implementation, the server 120 captures an interaction instruction, and sends the interaction instruction to the terminal 110. The terminal 110 determines, according to the interaction instruction, a first rendering object that is changed in a next frame of picture and object changed content corresponding to the first rendering object, renders, based on the object changed content, a first object layer corresponding to the first rendering object, and performs overlaying processing on the first object layer and a second object layer, to obtain the next frame of picture for display.

The method according to the embodiments may be applied to the terminal 110 (the application 111 in the terminal 110) or the server 120 in the implementation environment shown in FIG. 1. For ease of description, the following uses an example in which the method is applied to a computer device for schematic description.

FIG. 2 is a flowchart of a picture rendering method according to an exemplary embodiment of this application. This embodiment is described by using an example in which the method is applied to a computer device. The method includes the following operations.

Operation 201: Determine, according to an interaction instruction in an interaction process, a first rendering object that is changed in an (i+1)^{th}frame of interaction picture compared with an i^{th}frame of interaction picture and object changed content corresponding to the first rendering object.

In this embodiment of this application, layer division is performed, based on a plurality of rendering objects in the interaction process, on an interaction picture related tothe interaction process, to obtain object layers corresponding to different rendering objects. In other words, different object layers correspond to different rendering objects in the interaction picture. Corresponding rendering objects in the object layers obtained through division remain independent of each other. The computer device may process each object layer independently. In a rendering process of the interaction picture, a corresponding object layer may be rendered based on a change status of the next frame of picture. Only an object layer corresponding to a rendering object that is changed is rendered. For an object layer corresponding to a rendering object that is not changed, a previously rendered object layer may be reused. In other words, by separating rendering processes of different rendering objects, a possibility of repeated calculation and rendering is reduced, and single frame rendering workloads are reduced.

The interaction process includes any process in which the computer device (an application of the computer device) displays a corresponding picture in a running process, and the displayed picture is changed. The interaction instruction includes an instruction that is triggered in the interaction process and that causes the interaction picture to change. The interaction picture includes a picture displayed in an execution process of the interaction process. For example, when the application starts to be run and the picture corresponding to the application is displayed, it may be considered that the interaction process is started. A currently displayed picture of the application is changed by (the interaction instruction triggered by) an operation performed by a user in the application. When running of the application ends, it may be considered that the interaction process ends. In some embodiments, the interaction instruction includes at least one of a user instruction triggered by the user and a system instruction triggered by a system. For example, the user instruction includes an instruction triggered by the user through an operation. The operation may be detected by using a display screen, a physical key, an internal motion detection component, an external device, or the like of the computer device. For example, the instruction may be an instruction that is triggered by sliding the display screen and that instructs to slide content displayed in an interface. The system instruction includes an instruction that is triggered by the system and that instructs to change the interaction picture, for example, an instruction triggered at specified time configured for displaying activity information.

The rendering object includes all displayed objects in the interaction picture or a displayed object that is affected by the interaction instruction and changes, and the displayed object includes a displayed element in the interaction picture. In some embodiments, the computer device disassembles the displayed object depending on whether a displayed object that needs to be displayed in the interaction process is affected by the interaction instruction, to obtain a plurality of rendering objects. For example, the rendering objects include an object corresponding to a background of the interaction picture, an object corresponding to a virtual character controlled by the user in the interaction picture, an object corresponding to a control for controlling the virtual character in the interaction picture, and the like.

In a process of layer division of the rendering object, in some embodiments, the computer device extracts each rendering object from a rendered interaction picture corresponding to the rendering object, to obtain, through division, an object layer corresponding to the rendering object. Each object layer corresponds to one rendering object, that is, each object layer is configured to display one rendering object. In some embodiments, the computer device first classifies the rendering objects, and extracts a rendering object of each object type from a rendered interaction picture corresponding to the rendering object, to obtain, through division, the object layer corresponding to the rendering object of each object type. An object layer corresponding to each object type corresponds to one or more rendering objects, that is, each object layer is configured to display one or more rendering objects. For the object layer corresponding to each object type, the computer device can further divide the object layer based on a rendering object included in the object layer.

In a possible implementation, in the interaction process, the computer device may determine the change status of the next frame of interaction picture based on a captured interaction instruction. The interaction instruction is an instruction that causes the interaction picture to change in the interaction process. In some embodiments, the interaction instruction includes at least one of the system instruction and the user instruction. The system instruction is an instruction controlled by the system, for example, an instruction instructing the system to put an item in a virtual environment, control a non-user character in a virtual environment, simulate different natural or physical phenomena in a virtual environment, or the like. The user instruction is an instruction triggered by a user operation. For example, through a trigger operation on an attack control, the user triggers an action of the virtual character of the user to perform an attack; and through a trigger operation on a jump control, the user triggers an action of the virtual character of the user to perform a jump.

In a process of obtaining the interaction instruction, the system instruction and the user instruction triggered by the user need to be captured, to perform determination based on the captured interaction instruction. In a possible implementation, the system instruction and the user instruction may be captured in the interaction process by using a hook technology. When a terminal performs a picture rendering process, the system instruction is forwarded to each terminal by a server. However, for a user instruction triggered by each terminal, in a possible implementation, the server may capture the user instruction triggered by the terminal, and forward the user instruction to the terminal, and the terminal determines the first rendering object according to the user instruction. Alternatively, in another possible implementation, after capturing a user instruction triggered by each terminal, the server determines an affected rendering object according to the user instruction, and then forwards the user instruction to a terminal corresponding to the affected rendering object, so that the terminal performs processing. This is not limited in this embodiment.

The computer device determines, according to the interaction instruction in the interaction process, the first rendering object that is changed in the (i+1)^{th}frame of interaction picture compared with the i^{th}frame of interaction picture and the object changed content corresponding to the first rendering object, where i is a positive integer. The i^{th}frame of interaction picture and the (i+1)th frame of interaction picture are consecutive pictures intime, and the (i+1)^{th}frame of interaction picture is a next frame of picture of the i^{th}frame of interaction picture. The first rendering object includes a rendering object that is determined by the computer device, that is in at least one rendering object in the (i+1)^{th}frame of interaction picture, and that is changed compared with the i^{th}frame of interaction picture. The object changed content is configured for reflecting a specific change of the first rendering object compared with a corresponding rendering object in the i^{th}frame of interaction picture, and includes, for example, at least one of a display position (coordinate) change, a display status (for example, display content and a display form) change, a display size change, rendering object addition, and rendering object removal. Specific content of the object changed content is not limited in this embodiment of this application. For example, when receiving the triggering operation of the user on the jump control, it is determined that a virtual character controlled by the user in a next frame is the first rendering object, a position of the virtual character controlled by the user in the next frame is changed, and display content is also changed (the virtual character performs a jumping action).

In addition, because the interaction instruction may have a persistent impact on a plurality of consecutive frames of interaction pictures, in a rendering process of each frame of interaction picture, the computer device needs to traverse captured interaction instructions, and determine, according to an obtained interaction instruction that affects the i^{th}frame of interaction picture, a change status of the (i+1)′ frame of interaction picture compared with the i^{th}frame of interaction picture, to obtain corresponding object changedcontent.

Operation 202: Render, based on the object changed content, a first object layer corresponding to the first rendering object.

In a possible implementation, the computer device renders, based on the determined object changed content, the first object layer corresponding to the first rendering object. In addition, when object changed contents are different, the first object layer may be rendered in different rendering manners. For example, the computer device may perform layer re-rendering on the first object layer of the first rendering object, perform layer coordinate adjustment on the first object layer of the first rendering object, or perform layer coordinate adjustment and layer size adjustment on the first object layer of the first rendering object. The first object layer is obtained through division based on the corresponding first rendering object in the plurality of rendering objects in the interaction process.

In some embodiments, the computer device divides the rendered interaction picture based on the rendering object, to obtain object layers corresponding to different rendering objects. The object layers include the first object layer of the first rendering object. In some embodiments, the server divides the rendered interaction picture based on the rendering object, to obtain object layers corresponding to different rendering objects. The server may further send the object layer obtained through division to the computer device for subsequent rendering of the interaction picture. The rendered interaction picture includes the i^{th}frame of interaction picture, and can further include an interaction picture before the i^{th} frame of interaction picture.

In some embodiments, each rendering object displayed in the interaction picture corresponds to respective rendering data. The rendering data is configured for rendering a corresponding rendering object in the interaction picture. For example, the rendering data includes vertex information, mesh information, material information, map information, and the like of the rendering object. In other words, the interaction picture may be obtained through rendering by using rendering data of rendering objects, and combining rendering results of the rendering objects into one frame of picture. In some embodiments, by separately obtaining a rendering result corresponding to rendering data used when a rendering object is rendered in the rendered interaction picture, a division result of an object layer of the rendering object, that is, an object layer corresponding to the rendering object, may be obtained. In some embodiments, an object layer of a rendering object may be divided by extracting a corresponding display area of each rendering object in the rendered interaction picture. For example, the object layer of the rendering object may be obtained by performing matting on the corresponding display area of the rendering object in the interaction picture from the interaction picture. The display area includes an area that is occupied by a displayed rendering object when the rendering object is displayed in the interaction picture.

When a plurality of first rendering objects exist, the computer device respectively renders, based on object changed content corresponding to the first rendering objects, first object layers corresponding to the first rendering objects, to obtain the first object layers corresponding to the first rendering objects.

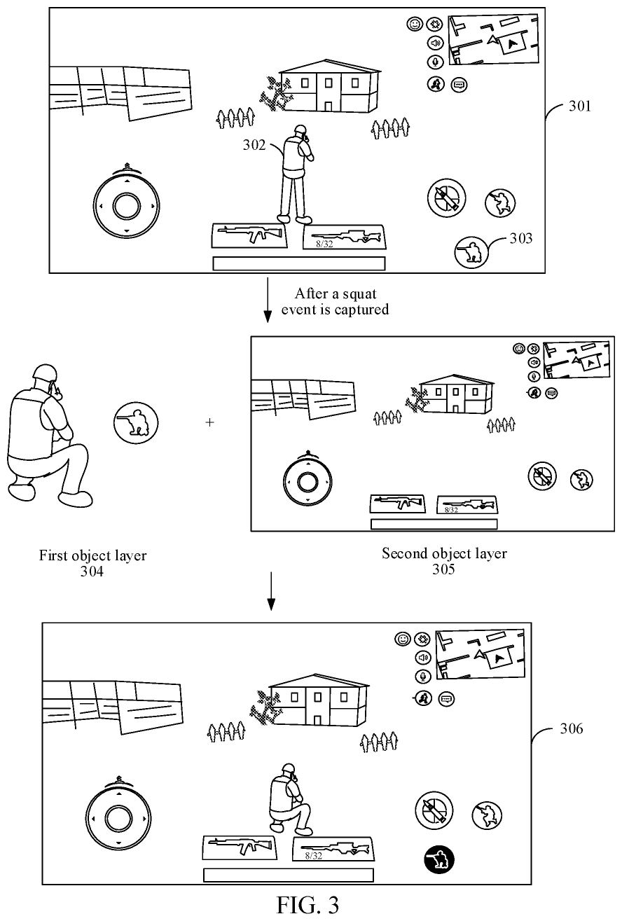

For example, as shown in FIG. 3, when a triggering operation of the user on a squat control 303 is received, the computer device captures a squat instruction. After capturing the squat instruction, the computer device determines that a first rendering object that is changed in an (i+1)^{th}frame of interaction picture compared with an i^{th}frame of interaction picture 301 is a virtual character 302 controlled by the user and the squat control 303. An object layer corresponding to the virtual character 302 and the squat control 303 needs to be rendered to obtain a first object layer 304.

Operation 203: Perform overlaying processing on the first object layer and a second object layer, to obtain the (i+1)^{th}frame of interaction picture, where the second object layer is an object layer corresponding to a second rendering object that is not changed between the (i+1)^{th}frame of interaction picture and the i^{th}frame of interaction picture.

In this embodiment of this application, based on the change status of the (i+1)^{th}frame of interaction picture (the object changed content of the first rendering object), the computer device may render the first object layer corresponding to the first rendering object. For the second object layer of the second rendering object, a corresponding object layer in the i^{th}frame of interaction picture may be reused without processing. In other words, in a rendering process of each frame of picture, the computer device only needs to render a changed object layer. In a layered rendering manner, there is no need to re-render a next frame of entire displayed picture, so that rendering workloads of a single frame of picture can be reduced. In some embodiments, after determining the first rendering object, the computer device determines, as the second rendering object, a rendering object in the i^{th}frame of interaction picture other than a rendering object corresponding to the first rendering object.

In addition, for the second object layer of the second rendering object, in addition to that the corresponding object layer in the i^{th}frame of interaction picture may be reused, an object layer corresponding to N frames of pictures before the i^{th} frame of interaction picture (when a plurality of consecutive frames are not changed), that is, a rendered layer, may be reused. If the corresponding rendering object is not changed, both the foregoing layers may be reused subsequently. This is not limited in this embodiment. N is a positive integer.

After obtaining the first object layer, the computer device may perform the overlaying processing on the first object layer and the second object layer, to obtain the (i+1)^{th}frame of interaction picture. In an overlaying processing process, object layers may be overlaid based on layer display orders and layer transparency.

In some embodiments, that the computer device performs the overlaying on the first object layer and the second object layer includes placing a rendered first object layer and second object layer in a same picture. For example, each rendered object layer corresponding to the (i+1)^{th}frame of interaction picture is placed in a same blank picture, so that a rendered (i+1)^{th}frame of interaction picture can be obtained. In this way, the (i+1)^{th}frame of interaction picture can be displayed. In a process of placing the object layers, if a position of a rendering object is not changed, the rendering object may be placed based on a previous position; or if a position of a rendering object is changed, the rendering object may be placed based on an updated position. Specifically, refer to corresponding object changed content. In addition, when object layers of different rendering objects are placed in a same picture, an intersection area exists between the object layers of the different renderingobjects, and a case of mutual blocking exists. In some embodiments, the computer device determines a layer display order corresponding to an object layer of each rendering object based on a position relationship between different rendering objects in the (i+1)^{th}frame of interaction picture, and places different object layers based on the layer display orders, to set a front-to-back blocking relationship between object layers. For example, an object layer with a higher layer display order may block an object layer with a lower layer display order. In some embodiments, when a rendering object is displayed, a case of translucent display may exist. In this case, the computer device needs to determine layer transparency corresponding to the object layer of each rendering object based on transparency of the different rendering objects in the (i+1)^{th}frame of interaction picture, and set the object layer to the corresponding layer transparency when the object layer is placed. The layer transparency is configured for reflecting a degree of transparency during display of the object layer of the rendering object. For example, 1 indicates complete transparency and 0 indicates complete opacity. Transparency closer to 1 indicates a higher degree of transparency during display. In some embodiments, when the layer display order and the layer transparency are not changed, the computer device obtains a layer display order and layer transparency of each rendering object in the (i+1)^{th} frame via the i^{th} frame of interaction picture or an interaction picture before the i^{th}frame, to be used when object layers of the (i+1)^{th}frame of interaction picture are overlaid. In some embodiments, when at least one of the layer display order and the layer transparency is changed, the computer device determines a layer display order and layer transparency of a rendering object in the (i+1)^{th}frame of interaction picture according to the interaction instruction, to be used when object layers of the (i+1)^{th}frame of interaction picture are overlaid.

For example, as shown in FIG. 3, the second rendering object includes a background object, a control object, and the like. The computer device may reuse a second object layer 305 in the i^{th} frame of interaction picture 301 to perform overlaying on the second object layer 305 and the first object layer 304, to obtain an (i+1)^{th} frame of interaction picture 306. The first rendering object in the (i+1)^{th}frame of interaction picture 306 is a picture in which the virtual character 302 squats.

The method according to this embodiment of this application may be performed by the terminal independently, or by the server and the terminal in cooperation, or by the server independently. For example, after obtaining the foregoing interaction instruction (obtained locally or obtained via the server), the terminal determines the (i+1)^{th}frame of interaction picture according to the interaction instruction and the i^{th}frame of interaction picture. Alternatively, after obtaining the foregoing interaction instruction (obtained locally or obtained via the terminal), the server determines the (i+1)^{th}frame of interaction picture according to the interaction instruction and the i^{th}frame of interaction picture, and sends the (i+1)^{th}frame of interaction picture to the terminal. Alternatively, after obtaining the foregoing interaction instruction (obtained locally or obtained via the terminal), the server determines the first object layer according to the interaction instruction and the i^{th}frame of interaction picture, and sends the first object layer to the terminal. The terminal determines the (i+1)^{th}frame of interaction picture based on the i^{th}frame of interaction picture and the first object layer. This is not limited in this embodiment.

Based on the above, in embodiments of this application, layer division is performed on a rendering object in the interaction process, to obtain an object layer corresponding to the rendering object. In an interaction process of the application, the computer device may determine in advance, according to a captured interaction instruction, a first rendering object that is changed in a next frame of picture waiting to be displayed compared with a current frame of picture, so that an object layer corresponding to the first rendering object is rendered independently. For a second object layer corresponding to a second rendering object that is not changed in a next frame, an object layer that has been rendered in the history may be reused. Finally, the next frame of picture is obtained in a manner of performing layer overlaying on the first object layer and the second object layer, so that rendering of the next frame of picture is completed. In this manner, because the second object layer that has been rendered before is reused when the next frame of picture is rendered, and there is no need to perform rendering again, when image quality of the application is unchanged, performance consumption of rendering a single frame of picture may be reduced, and rendering duration may be shortened, so that the application can be supported to run for long time in a high image quality and high frame rate mode. This helps improve picture smoothness of the application.

In this embodiment of this application, in a manner of object layer division and layered rendering, in a process of rendering the single frame of picture, only an object layer of a rendering object that is changed compared with a previous frame needs to be rendered. The object layer is a pre-divided layer. In a possible implementation, first, a displayed object that needs to be displayed in the interaction process is disassembled to obtain a plurality of rendering objects, and then layer division is performed, based on the plurality of rendering objects, on the interaction picture related to the interaction process. A layer division manner is illustratively described below.

In a possible implementation, a layer division process may include the following operations.

Operation 1: Disassemble, based on a displayed object affected by the interaction instruction, the displayed object that needs to be displayed in the interaction process, to obtain the plurality of rendering objects.

Various displayed objects exist in the interaction picture related to the interaction process, and may be changed under different interaction instructions. In a possible implementation, different displayed objects may be disassembled based on a displayed object affected by each interaction instruction. For example, each displayed object that may be affected by the interaction instruction and a displayed object that is not affected by the interaction instructions are used as granularities, different displayed objects are disassembled, and the displayed object that may be affected by the interaction instruction is used as a rendering object.

Generally, the displayed object that needs to be displayed in the interaction process includes the virtual character controlled by the user, background information, prompt information, a control, and the like. Different interaction instructions may affect different virtual characters. For example, for a non-user character, when the system delivers a related interaction instruction, the non-user character may be changed. However, for a user character, different operation instructions of the user may affect different characters. Therefore, basedon impact of the interaction instructions on different virtual characters, the user character and the non-user character may be obtained through disassembling. The user character is controlled by the user, and the non-user character is controlled by the system. In addition, for different user characters, because the different user characters change according to operations of different users, disassembling may further be performed according to different user instructions to obtain the user characters corresponding to the different users. For non-user characters, different system instructions are directed to different non-user characters. Therefore, disassembling may further be performed according to the different system instructions, to obtain the non-user characters corresponding to the different systeminstructions.

In addition, a background picture displayed in the interaction process is also changed. For example, in a moving process of the virtual character, a switching process of a picture perspective, a process in which the system simulates a natural environment change, and the like, the background picture is correspondingly changed. Therefore, a displayed object in the background picture may be disassembled based on background objects affected by different instructions. For example, a static background object and a dynamic background object may be obtained through disassembling. The dynamic background object is changed periodically or non-periodically with a factor such as time, for example, may be a tree, rain, and fog. A display status of the static background object, for example, a building, is notchanged.

For displayed prompt information configured for prompting the user, for example, when orientation of the virtual character of the user is changed, orientation prompt information is changed; or when a position of the user is changed, a position in map information is changed. Different displayed prompt information may be disassembled into different rendering objects based on impact of different interaction instructions on the promptinformation.

In addition, for different controls, different operations may affect the different controls. For example, for a direction controlling control and a skill casting control, a form is changed with a user operation, and different item statuses may also affect the different controls. For example, a virtual ammunition filling control is changed with a virtual ammunition amount. Therefore, different control objects may be disassembled into different rendering objects based on controls affected by different operations and different items.

Operation 2: Perform, based on the plurality of rendering objects, the layer division on the interaction picture related to the interaction process, to obtain a plurality of object layers.

After obtaining the plurality of rendering objects, the computer device may perform the layer division based on the rendering objects.

In a possible implementation, the layer division is performed on the interaction picture based on each rendering object obtained through disassembling, to obtain an object layer corresponding to the rendering object. In other words, any rendering object may be disassembled to obtain a corresponding object layer. For example, each virtual character, background object, prompt information, control, and the like obtained through disassembling corresponds to an object layer.

In this manner, in a subsequent layer overlaying process, due to a large number of layers, the overlaying process is complex, and may affect picture rendering efficiency. Therefore, in another possible implementation, the rendering objects may be classified first, and the layer division is performed based on different types of rendering objects. The process may include the following operations.

Operation 1: Classify the plurality of rendering objects, to obtain the rendering objects of the different object types.

The computer device may classify the rendering objects based on an element types corresponding to each rendering object, to obtain the rendering objects of the different object types. In some embodiments, the rendering objects may be classified to obtain a background object type, a character object type, and a control object type.

Operation 2: Perform the layer division on the interaction picture based on the different object types, to obtain object layers corresponding to the different object types.

Layer division is performed based on the object types, to obtain the object layers corresponding to the different object types. In some embodiments, the computer device may perform the layer division on the interaction picture based on the different object typesto obtain a background object layer, a character object layer, and a control object layer.

For the background object layer, an object of the background picture type may be grouped into the layer. In addition, the background object layer may be further divided to obtain different background sub-layers. In some embodiments, the computer device divides the background object layer to obtain a static background sub-layer and a dynamic background sub-layer. The static background sub-layer includes a layer corresponding to a static (not changed with the interaction instruction) background picture object, and the dynamic background sub-layer includes a layer corresponding to a dynamic (changed with the interaction instruction) background picture object.

For the character object layer, the virtual character may be grouped into the layer. In addition, the character object layer may be further divided to obtain different character sub-layers. In some embodiments, the computer device divides the character object layer to obtain a user character sub-layer and a non-user character sub-layer. In addition, the user character sub-layer may be further divided to obtain sub-layers corresponding to virtual characters corresponding to different users. The non-user character sub-layer may be further divided to obtain sub-layers corresponding to different non-user characters.

For the control object layer, different controls displayed in the interaction picture may be grouped into the layer. In addition, similarly, the control object layer may be further divided to obtain different control sub-layers. In some embodiments, the computer device divides the control object layer to obtain an action control sub-layer and a prompt control sub-layer. In other words, a control that controls the virtual character to perform an action is grouped into one layer through division, and a control configured for prompting may be grouped into one layer through division. It is clear that each independent display control may alternatively be grouped into one layer through division. This is not limited in thisembodiment.

For the rendering object disassembling and layer division processes, automatic disassembling and automatic division may be performed by the computer device according to a disassembling rule and a division rule, or manual disassembling and division may be performed in advance by a developer. This is not limited in this embodiment.

In this embodiment, the displayed object disassembling and the layer division are performed, so that a rendering object included in each object layer obtained through division are kept independent. In this way, a possibility of repeated calculation and rendering is reduced. This helps improve single frame rendering efficiency.

Based on the above, in this embodiment of this application, by screening a rendering object affected by the interaction instruction and performing layer division on the rendering object, layer division may be prevented from being performed on a displayedobject not affected by the interaction instruction, to avoid a waste of resources. Layer division is performed on each rendering object, so that each rendering object can be completely independent. This can avoid data association in a subsequent processing process. By classifying the rendering objects and performing layer division based on a classification result, a number of divided layers can be reduced. This helps simplify the subsequent processing process and improve picture rendering efficiency. By dividing the background object layer, the character object layer, and the control object layer, the layer division is implemented with reference to an actual situation, and a proper layer division manner is provided. By further dividing each type of layer, fineness of the divided layer can be improved, to facilitate subsequent use of each type of layer.

The computer device determines the object changed content of the (i+1)^{th}frame of interaction picture according to the interaction instruction. Different object changed content corresponds to different layer rendering manners. Descriptions are provided below by using an exemplary embodiment.

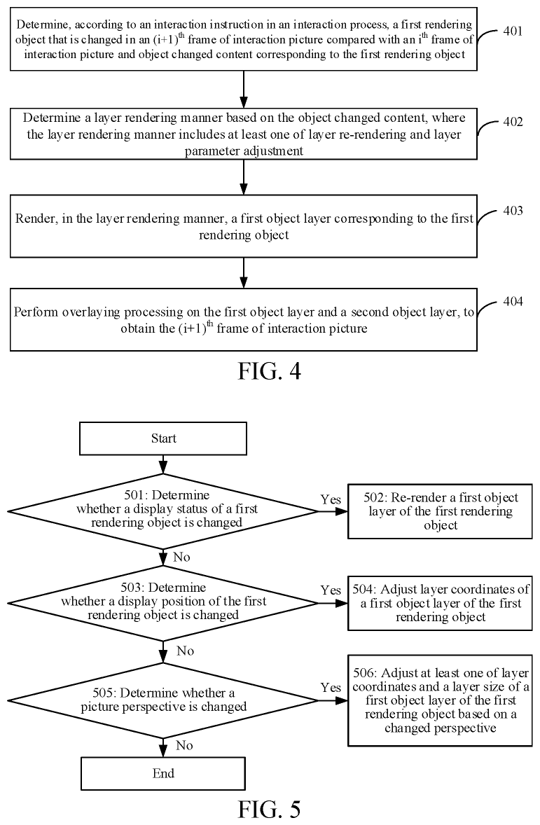

FIG. 4 is a flowchart of a picture rendering method according to an exemplary embodiment of this application. This embodiment is described by using an example in which the method is applied to a computer device. The method includes the following operations.

Operation 401: Determine, according to an interaction instruction in an interaction process, a first rendering object that is changed in an (i+1)^{th}frame of interaction picture compared with an i^{th}frame of interaction picture and object changed content corresponding to the first rendering object.

For implementation of operation 401, refer to the foregoing operation 201. Details are not described in this embodiment again.

Operation 402: Determine a layer rendering manner based on the object changed content, where the layer rendering manner includes at least one of layer re-rendering and layer parameter adjustment.

Different interaction instructions lead to different changes of the first rendering object. For example, a display position of prompt information is fixed, and content is changed with the interaction process. Possible changes of a virtual character includes: in a moving process, a display form is not changed, and only a position is changed; or in an execution process of an action, a size, a form, and the like are changed, and an action of another virtual character may further affect a change of a local virtual character. A display control generally has a fixed position, and display content remains consistent. However, for some special cases, a corresponding change may occur depending on different scenes of the virtual character. For example, a control in a game has a different display status from a control before entering the game. For another example, when the control is configured to prompt the user of being in a cooldown, a status of the control is changed. Based on the above, various types of object changed content may include the following: that object content is changed and an object position and an object size are not changed, for example, display of prompt information and display of control content; that the object position is changed and the object content and the object size are not changed, for example, a picture background is displaced in a moving process of the virtual character; that an object form, for example, the object size or an object posture, is changed, including stopping being displayed or the like; and that a picture perspective is changed and the object content is not changed, for example, when the user switches a perspective, the picture perspective is changed, and the interaction picture is changed as the picture perspective is changed.

Based on different object changed content, different layer rendering manners may be determined. When the object changed content indicates that a first object layer is changed greatly, the first object layer may be re-rendered. However, when the object changed content indicates that the first object layer has little change, there is no need to re-render the layer, and only information in the layer needs to be adjusted. In different cases, adjustment manners are different. A layer change degree is configured for reflecting a magnitude of a change of the first object layer after being affected by the interaction instruction, and may be measured based on a similarity between the first object layer before the change and a changed first object layer. In a possible implementation, the following cases may be included.
1. When the object changed content indicates that a display status of the first rendering object is changed, determine that the layer rendering manner is the layer re-rendering, where the display status includes at least one of display content and a display form.

When the computer device determines that the display content or the display form of the first rendering object is changed, a great change exists in the first rendering object, and the corresponding first object layer needs to be re-rendered, that is, it is determined that the layer rendering manner is the layer re-rendering.

For example, after the user triggers the virtual character to get changed, display content of the virtual character needs to be changed. In this case, an object layer corresponding to the virtual character needs to be re-rendered. For example, after the user triggers the virtual character to change an action, a display form of the virtual character needs to be changed (for example, from standing to squatting). In this case, an object layer corresponding to the virtual character needs to be re-rendered.
2. When the object changed content indicates that a display position of the first rendering object is changed, determine that the layer rendering manner is layer coordinateadjustment.

In a possible implementation, the computer device may first determine the display content or the display form of the first rendering object. When the display content or the display form is not changed, there is no need to re-render the layer. The computer device may continue to determine whether the display position of the first rendering object is changed. When the display position is changed, it is determined that the layer rendering manner is the layer parameter adjustment. Specifically, for a case that the display position is changed, the layer parameter adjustment manner may be the layer coordinate adjustment. The computer device may adjust layer coordinates based on a changed position. In other words, when only the first rendering object is displaced, the layer rendering manner is the layer coordinate adjustment.

For example, when a position of the virtual character is changed, the computer device may adjust layer coordinates of only an object layer corresponding to the virtual character. For example, the position of the virtual character is changed through tele-porting, but an action of the virtual character is not changed.
3. When the object changed content indicates that the picture perspective is changed, determine that the layer rendering manner is at least one of layer coordinate adjustment and layer size adjustment.

When the computer device determines that a display status and a display position of the first rendering object are not changed but the picture perspective is changed, the computer device may determine that the layer rendering manner is the layer parameteradjustment.

A change of the picture perspective may include zooming in and zooming out of the perspective, up and down or left and right translation of the perspective, and the like. Therefore, for the case that the picture perspective is changed, the layer parameter adjustment manner includes at least one of the layer coordinate adjustment and the layer size adjustment. In other words, in the case that only the picture perspective is changed, the layer rendering manner includes at least one of the layer coordinate adjustment and the layer size adjustment.

For example, when the picture perspective is switched from far to near, a display scale of the first rendering object becomes larger, and a layer size needs to be adjusted; when the picture perspective is translated left and right, the first rendering object is also translated, and layer coordinates need to be adjusted.

Operation 403: Render, in the layer rendering manner, the first object layer corresponding to the first rendering object.

In a possible implementation, when the layer rendering manner is the layer re-rendering, the computer device re-renders the first object layer corresponding to the first rendering object; when the layer rendering manner is the layer coordinate adjustment, the computer device re-adjusts coordinate information of the first object layer; or when the layer rendering manner is the layer size adjustment, the computer device adjusts the layer size of the first object layer.

In addition, in an actual interaction process, a plurality of rendering objects may be changed at the same time. Therefore, after determining first rendering objects, the computer device determines a layer rendering manner of an object layer corresponding to each first rendering object. With reference to the foregoing descriptions, a process of determining the layer rendering manner may be shown in FIG. 5.

Operation 501: Determine whether the display status of the first rendering object is changed; and if the display status is changed, perform operation 502; or if the display status is not changed, perform operation 503.

Operation 502: Re-render the first object layer of the first rendering object.

Operation 503: Determine whether the display position of the first rendering object is changed; and if the display position is changed, perform operation 504; or if the display position is not changed, perform operation 505.

Operation 504: Adjust layer coordinates of the first object layer of the first rendering object.

Operation 505: Determine whether the picture perspective is changed; and if the picture perspective is changed, perform operation 506.

Operation 506: Adjust at least one of the layer coordinates and the layer size of the first object layer of the first rendering object based on a changed perspective.

Operation 404: Perform overlaying processing on the first object layer and a second object layer, to obtain the (i+1)^{th}frame of interaction picture.

After each first object layer is obtained through rendering, the computer device then performs overlaying on each first object layer and the second object layer in the i^{th}frame of interaction picture, to obtain the (i+1)^{th} frame of interaction picture.

In the foregoing manner, the first rendering object that is changed in the (i+1)^{th}frame of interaction picture compared with the it frame of interaction picture may be determined based on the interaction instruction. However, in a possible case, when aspecified interaction instruction occurs, a great change exists in the interaction picture. In this case, if layered rendering is performed, more layers need to be rendered, and a process of layer overlaying is complex and inefficient.

Therefore, in a possible implementation, when the interaction instruction is the specified interaction instruction, overall picture rendering is performed on the (i+1)^{th}frame of interaction picture, where a picture change amplitude instructed by the specified interaction instruction is greater than a picture change amplitude instructed by another interactioninstruction.

A developer may preset the specified interaction instruction. For example, an interaction instruction that instructs a picture change amplitude of over 50% of a picture may be determined as the specified interaction instruction. For example, the specified interaction instruction may be a type of instruction that triggers a special effect. After capturing the interaction instruction, the computer device first determines whether the interaction instruction is the specified interaction instruction. If the interaction instruction is the specified interaction instruction, the (i+1)^{th}frame of interaction picture may be directly rendered. If the interaction instruction is an interaction instruction other than the specified interaction instruction, the first rendering object that is changed in the (i+1)^{th}frame of interaction picture compared with the i^{th}frame of interaction picture and the object changed content are determined according to the interaction instruction, to improves single frame rendering efficiency in a layered rendering manner.

For example, when the specified interaction instruction includes throwing a smoke, after the user controls the virtual character to throw the smoke, the computer device performs overall picture re-rendering, and no longer performs the layered rendering, to improve the rendering efficiency.

In other words, when the interaction instruction is captured, the computer device first determines whether the interaction instruction is the specified interaction instruction. When the interaction instruction is the specified interaction instruction, because a great change exists in an overall picture amplitude, efficiency of the layered rendering is lower than efficiency of the overall picture rendering. Therefore, when the interaction instruction is the specified interaction instruction, the overall picture re-rendering may be directly performed, and the layered rendering is not performed.

When the interaction instruction is a non-specified interaction instruction, rendering is performed in the layered rendering manner. In this process, the computer device may further determine the changed content of the first rendering object according to the non-specified interaction instruction. The object layer is re-rendered when the display status of the first rendering object is changed. However, when the display status of the first rendering object is not changed and the display position is changed, the layer coordinates are adjusted based on the changed position, so that re-rendering is not required. This reduces rendering workloads. Still further, when neither the display status nor the display position is changed, but the picture perspective is changed, the layer coordinates and the layer size of the layer may be adjusted based on a change between the changed perspective and a perspective before the change, so that the layer does not need to be re-rendered. This reduces the renderingworkloads.

In other words, in this embodiment, when the interaction instruction is a specified interaction instruction that instructs a great picture change amplitude, the (i+1)^{th} frame of interaction picture is directly rendered in the overall picture rendering manner. When the interaction instruction is another interaction instruction, the (i+1)^{th}frame of interaction picture is then obtained through rendering in the layered rendering manner. Most efficient rendering manners are selected for rendering under different interaction instructions, to improve the rendering efficiency.

In this embodiment, first, selection is performed between the overall picture rendering manner and the layered rendering manner according to the interaction instruction. After determining to use the layered rendering manner, the computer device may further determine the first rendering object according to the interaction instruction, and determine a layer rendering manner of each layer based on the object changed content corresponding to the first rendering object. The layer rendering manner may be dynamically adjusted based on the object changed content. When a layer is changed greatly (for example, a display status of an object is changed), the layer may be re-rendered. When a layer is changed insignificantly (for example, only a display position is changed or a picture perspective is changed), only a layer parameter may be adjusted, and not all layers need to be re-rendered. This may further improve efficiency of the layered rendering. In this way, the single frame renderingefficiency is improved. By determining, in sequence, a change of a display status of a rendering object, a change of a display position of the rendering object, and a change of a picture perspective, a corresponding layer rendering manner is selected. Because each change has a corresponding layer rendering manner, repeated determining is not involved. This can ensure accuracy of the selected layer rendering manner and improve efficiency of the selected layer rendering manner.

When the interaction instruction occurs, blocking statuses of rendering objects in the interaction picture are different in different situations, and display transparency may also be different. Therefore, in a layer overlaying process, the computer device further needs to dynamically adjust a layer display order and layer transparency. Descriptions are provided below by using an exemplary embodiment.

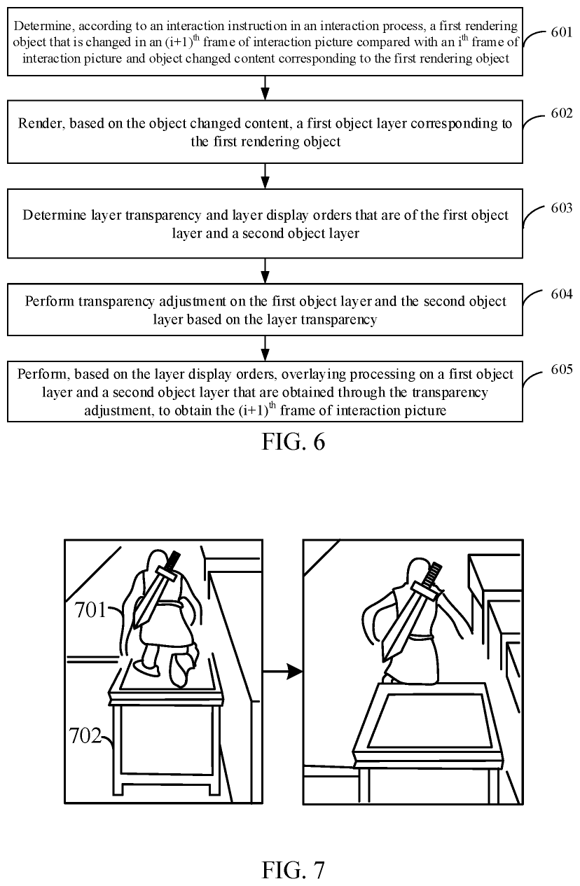

FIG. 6 is a flowchart of a picture rendering method according to another exemplary embodiment of this application. This embodiment is described by using an example in which the method is applied to a computer device. The method includes the following operations.

Operation 601: Determine, according to an interaction instruction in an interaction process, a first rendering object that is changed in an (i+1)^{th}frame of interaction picture compared with an i^{th}frame of interaction picture and object changed content corresponding to the first rendering object.

For implementation of operation 601, refer to the foregoing operation 201. Details are not described in this embodiment again.

Operation 602: Render, based on the object changed content, a first object layer corresponding to the first rendering object.

For implementation of operation 602, refer to the foregoing operations 402 and 403. Details are not described in this embodiment again.

Operation 603: Determine layer transparency and layer display orders that are of the first object layer and a second object layer.

A change of a rendering object is caused by the interaction instruction, and a change of a blocking order and display transparency that are of rendering objects may further be included. Because layering has been performed, when a blocking status of the rendering objects is changed, a display order of each layer may be adjusted to achieve differentblocking effects. For example, when a layer A is located above a layer B, an effect that a rendering object corresponding to the layer A blocks a rendering object corresponding to the layer B is exhibited. In addition, display transparency of the rendering object may be adjusted in a layer transparency adjusting manner. In this manner, there is no need to re-render a picture when the blocking effect is changed or the transparency is changed, so that rendering workloads can be reduced and rendering efficiency can be improved. In a possible implementation, after the first object layer is obtained through rendering, the computer device further needs to determine a layer display order and layer transparency that are of each layer. The layers include the first object layer and the second object layer. In this way, the display order and the transparency of each layer is dynamically adjusted.

In a possible implementation, the computer device determines the layer transparency of the first object layer and the second object layer according to the interactioninstruction.

Some interaction instructions affect the transparency of the layer, and may affect layer transparency of a plurality of consecutive frames. In other words, layer transparency of the first object layer may be changed, and transparency of the second object layer may also be changed. Therefore, the computer device may determine layer transparency of each layer in the (i+1)^{th}frame of interaction picture according to a captured interactioninstruction.

For example, after a user controls a virtual character to throw a virtual smoke in a virtual environment, as time increases, a smoke effect gradually dissipates. Correspondingly, transparency of the virtual character in the smoke in the (i+1)^{th}frame of interaction picture is higher than transparency of the i^{th} frame of interaction picture, that is, layer transparency of the virtual character in the smoke needs to be increased.

In addition, in a possible implementation, the computer device may determine the layer display order of each layer according to the interaction instruction, and then perform overlaying processing based on the layer display order.

Actually, the layer display order is usually changed when the first rendering object exists. If the layer display order of each layer is determined according to the interaction instruction in each frame, efficiency of a layer overlaying process is affected. Therefore, in another possible implementation, the computer device determines a first layer display order of the first object layer according to the interaction instruction, and determines a second layer display order of the second object layer based on the i^{th}frame of interactionpicture.

In other words, when the first rendering object exists, after the first object layer is obtained through rendering, the first layer display order of the first object layer is determined. For a layer display order of the second object layer, a second layer display order corresponding to the i^{th}frame of interaction picture may be reused, to reduce an amount ofprocessing.

For example, as shown in FIG. 7, when a virtual character 701 located on an obstacle 702 performs a jumping action and moves behind the obstacle 702, correspondingly, a character object layer corresponding to the virtual character 701 is adjusted, to being below the obstacle object layer, from being above an obstacle object layer corresponding to the obstacle 702, so that a blocking effect of the obstacle 702 on the virtual character 701 is represented in the (i+1)^{th}frame of interaction picture.

In addition, no first rendering object exists in the (i+1)^{th}frame of interaction picture compared with the i^{th}frame of interaction picture, and a change only exists in layer transparency. Therefore, in a process of processing each frame of picture, the computer device needs to determine whether the change exists in the layer transparency.

However, for the layer display order, when the first rendering object exists, a change exists in the layer display order. When no first rendering object exists in the (i+1)^{th}frame of interaction picture compared with the i^{th}frame of interaction picture, there is no need to determine the layer display order again.

Further, a layer display order of object layers corresponding to some rendering objects may remain unchanged at all times. For example, each operation control is always displayed on an uppermost layer of a picture. Therefore, a layer having an unchanged order may be preset. In an overlaying processing, there is no need to determine a layer display order of the layer having the unchanged order. This reduces the amount of processing.

In addition, some object layers that correspond to rendering objects and whose layer transparency remains unchanged also exist, for example, orientation prompt information of the virtual character in the picture is unchanged. Therefore, for a layer with unchanged transparency, there is no need to determine layer transparency of this type of layer in the overlaying processing process, so that the amount of processing can be reduced.

Operation 604: Perform transparency adjustment on the first object layer and the second object layer based on the layer transparency.

After determining layer transparency of each layer, the computer device may determine an object layer whose transparency needs to be changed, and perform, based on an adjustment requirement, transparency adjustment on an object layer that needs to be adjusted and that is in the first object layer and the second object layer.

Operation 605: Perform, based on the layer display orders, overlaying processing on a first object layer and a second object layer that are obtained through the transparency adjustment, to obtain the (i+1)^{th}frame of interaction picture.

After the transparency adjustment is completed, the computer device may perform, based on the determined layer display order, the overlaying processing on the first object layer and the second object layer that are obtained through the transparency adjustment, to obtain the (i+1)^{th}frame of interaction picture.

In this embodiment, in the layer overlaying processing process, the computer device determines the layer transparency and the layer display order of the layer, and performs overlaying on the object layers in this manner, to ensure accuracy of performing the overlaying processing on the object layers. In this way, accuracy of displaying of the interaction picture is ensured. In addition, the layer transparency and the layer display order are dynamically adjusted according to the interaction instruction. This can ensure the accuracy of performing the overlaying processing on the object layers when the interaction instruction affects the layer transparency and the layer display order. In addition, in a process of determining the layer display order, only a layer display order of the first object layer may be determined. For a layer display order of another second object layer, a layer display order corresponding to a previous frame of picture may be reused. This may improve processing efficiency and help improve single frame rendering efficiency.

In a possible case, a third rendering object that is no longer displayed may exist in the (i+1)^{th}frame of interaction picture compared with the i^{th}frame of interaction picture, and a third object layer corresponding to the third rendering object needs to be deleted. However, the third rendering object that is no longer displayed in the (i+1)^{th}frame of interaction picture may need to be continued to be displayed in a subsequent picture. If the third object layer is directly deleted, re-rendering needs to be performed in a subsequent displaying process. To further improve the single frame rendering efficiency, for a third rendering object that is currently stopped being displayed, the computer device may first store a corresponding third object layer in a cache for subsequent use.

When determining that the third rendering object that needs to be stopped being displayed exists in the (i+1)^{th} frame of interaction picture compared with the i^{th} frameof interaction picture, the computer device deletes the third object layer corresponding to the third rendering object in the i^{th}frame of interaction picture compared with the (i+1)^{th}frame of interaction picture, and stores the third object layer in the cache. The third rendering object is a rendering object that is no longer displayed in the (i+1)^{th}frame of interaction picture compared with the i^{th}frame of interaction picture.

For example, after the user switches the picture perspective, a virtual character A in the i^{th}frame of interaction picture is located outside the picture, that is, the virtual character A is no longer displayed in the (i+1)^{th} frame of interaction picture. If theperspective is switched back again subsequently, the virtual character A may need to be continued to be displayed. Therefore, in a process of processing the (i+1)^{th} frame of interaction picture, an object layer A corresponding to the virtual character A is deleted, and the object layer A is stored in the cache, so that the corresponding object layer is directly obtained from the cache subsequently, and re-rendering is not required.

In some embodiments, when a fourth rendering object exists in the (i+1)^{th}frame of interaction picture compared with the i^{th} frame of interaction picture, the computer device searches the cache for a fourth object layer corresponding to the fourth renderingobject.

Because the cache stores an object layer, when the newly added fourth rendering object exists in the (i+1)^{th} frame of interaction picture compared with the i^{th} frame of interaction picture, the cache may be searched for whether the fourth object layer corresponding to the fourth rendering object exists. If the fourth object layer exists, the fourth object layer may be obtained. If the fourth object layer does not exist, an object layer corresponding to the fourth rendering object is re-rendered.

In a possible implementation, if a display status, a display position, and the like of the fourth object layer obtained from the cache by the computer device is the same as that of a fourth rendering object indicated by the object changed content, the fourth object layer may be directly determined as the first object layer. If display statuses are different, re-rendering is still required to obtain the first object layer. If display statuses are the same and display positions are different, layer coordinate adjustment may be performed on the obtained fourth object layer to obtain the first object layer.

The object layer stored in the cache may continuously occupy the cache if the object layer is always stored. Therefore, in a possible implementation, the computer device removes the third object layer from the cache when caching duration of the third object layer reaches a caching duration limit. In this way, continuous occupation of the cache is avoided.

Further, because a rendering object may only need to be temporarily displayed once in the interaction picture, this type of rendering object does not need to be stored in the cache after the rendering object is stopped being displayed. This avoid occupying storage space. In a possible implementation, when storing each third rendering object, the computer device may first determine whether the third rendering object is a repeated rendering object in the interaction process, and then store a corresponding object layer in the cache when thethird rendering object is the repeated rendering object. The repeated rendering object may be preset by a developer. In the interaction process, after the third rendering object is detected, it is determined whether the third rendering object belongs to the preset repeated rendering object, and if the third rendering object belongs to the preset repeated rendering object, the third rendering object is stored in the cache.

In this embodiment, for a rendering object that is temporarily and no longer displayed, the computer device may store a corresponding object layer in the cache. If the rendering object needs to be continued to be displayed subsequently, the corresponding object layer may be obtained from the cache. This avoids re-rendering, and helps improve rendering efficiency. By determining whether caching duration of the object layer stored in the cache reaches the caching duration limit, and deleting the object layer, continuous occupation of storage resources may be avoided.

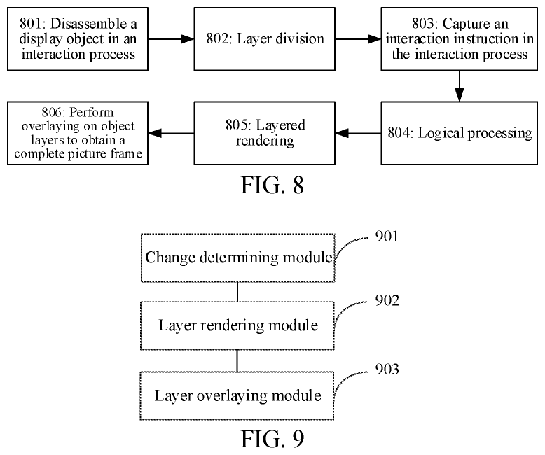

In a possible implementation, a picture rendering process is shown in FIG. 8, and includes the following operations.

Operation 801: Disassemble a displayed object in an interaction process.

A computer device may disassemble the displayed object in the interaction process based on impact of different interaction instructions on the displayed object, and disassemble the displayed object into a plurality of rendering objects that are relatively independent of each other.

Operation 802: Layer division.

The computer device may classify the rendering objects obtained through the foregoing disassembling, and perform the layer division based on types, to obtain different object layers.

Operation 803: Capture an interaction instruction in the interaction process.

After an application starts up, the computer device may obtain the interaction instruction in the interaction process in real time, to determine a change status of each frame of picture according to the interaction instruction.

Operation 804: Logical processing.

After capturing the interaction instruction, the computer device may perform the logic processing according to the interaction instruction, to determine a rendering object affected by the interaction instruction and impact of the interaction instruction on a displayed picture, that is, determine a first rendering object that is changed in an (i+1)^{th}frame of interaction picture compared with an i^{th} frame of interaction picture and object changed content that are in the foregoing embodiment.

In some embodiments, after determining the first rendering object and the object changed content, the computer device inputs first description information, second description information, third description information, and guidance information into a large language model (LLM), to obtain a reserved computing resource predicted by the large language model. Then, the reserved computing resource is amplified, and resource reservation is performed on an amplified reserved computing resource.

The amplified reserved computing resource is configured for rendering a first object layer corresponding to the first rendering object. The computer device multiplies the reserved computing resource by an amplification factor, to obtain the amplified reserved computing resource. The amplification factor is set manually, for example, by a user. That the resource reservation is performed on the amplified reserved computing resource includes releasing a part of computing resources currently consumed by the computer device, to reserve a computing resource greater than the amplified reserved computing resource, so that the computing resource is configured for rendering the first object layer.

The first description information is configured for describing computing resources of the computer device, for example, a central processing unit (CPU) resource, a graphic processing unit (GPU) resource, and a random access memory (RAM) resource that are of the computer device and that are described in natural language. The first description information is generated by obtaining the computing resources of the computer device. The second description information is configured for describing the first rendering object (a rendering parameter of the first rendering object), for example, a rendering size of the first rendering object, model accuracy of the first rendering object, color information of the first rendering object, and the like. The third description information is configured for describing the object changed content, and may further include a used rendering manner. In some embodiments, the computer device queries a comparison table based on the obtained first rendering object and the object changed content, to obtain the second description information and the third description information. A correspondence between different description information, and different first rendering objects and different object changed content is predefined in the comparison table. The comparison table is manually set, for example, set based on each rendering object and corresponding possible object changed content. The guidance information may be referred to as a prompt. The guidance information is configured for guiding the large language model to predict, when the object changed content is generated, a reserved computing resource consumed in the computing resources of the computer device by rendering the first rendering object. The predicting may be considered as predicting a computing resources required for rendering the first object layer.

For example, the first description information is “CPU 8 cores, frequency 3 GHz, GPU 24 cores, frequency 600 MHZ, and RAM 12G”, the second description information is “a changed rendering object is a human-shaped user character, and a rendering size is 300 px*100 px, precision 300 dpi, and color 10 bits”, the third description information is “the object changed content is putting on a piece of clothing in the upper half of the user character”, the guidance information is “how many inputted computing resources may be consumed when the user character is changed and rendered based on inputted object changed content”, and the reserved computing resource outputted by the large language model is “CPU 0.8 GHz, GPU 200 MHz, and RAM 1G”. Because rendering usually consumes a large number of computing resources, by reserving, in advance in the computer device before rendering, a computing resource that meets a rendering requirement, smooth running of the rendering process can be ensured, and a frame rate decrease caused by freezing of the rendering process may be avoided.

The foregoing large language model is an artificial intelligence model, and is intended to understand and generate human language. The model is trained based on a large amount of text data and may perform various tasks, including text summarization, translation, sentiment analysis, and the like. A characteristic of the LLM is a large scale, and includes billions of parameters that help the model to learn a complex pattern in language data. In some embodiments, a condition prediction model in this application is a large language model, and supports natural language generation.

Operation 805: Layered rendering.

After determining impact on the displayed picture according to the interaction instruction, the computer device separately renders a first object layer corresponding to each first rendering object.

Operation 806: Perform overlaying on object layers to obtain a complete picture frame.

The computer device performs the overlaying processing on the first object layer and a second object layer based on a layer display order and layer transparency, to obtain the complete picture frame. The second object layer is an object layer corresponding to a second rendering object that is not changed.

In some embodiments, the method provided in this application may be applied to the field of games. In this case, the interaction process described above may be referred to as a gaming process. The rendering object includes an object rendered (displayed) in a game picture in a running process of a game. The interaction instruction includes at least one of an instruction triggered by a player operation and an instruction triggered by a game system through an event, for example, is an instruction used by a player to control a virtual character located in a virtual environment to perform an activity. The activity of the virtual character includes but is not limited to at least one of adjusting a body posture, crawling, walking, running, riding, flying, jumping, driving, picking up, shooting, attacking, throwing, and casting a skill. The interaction picture includes a picture displayed in the running process of the game, and may specifically include a game picture in which the virtual environment is involved (displayed) in the game picture, for example, a game picture in which the player participates in a game in the game. The foregoing game includes any one of games such as a multiplayer online battle arena (MOBA) game, a battle royale shooting game, and a simulation game (SLG). A type of the game is not limited in the embodiments of thisapplication.

In this application, a prompt interface, a pop-up window, or voice prompt information may be displayed before and in collection of related data about the user (for example, related information about the virtual character of the user). The prompt interface, the pop-up window, or the voice prompt information is configured for prompting the user that the related data about the user is currently being collected. In this application, only after a confirmation operation performed by the user on the prompt interface or the pop-up window is obtained, a related operation of obtaining the related data about the user starts to be performed. Otherwise (in other words, when the confirmation operation performed by the user on the prompt interface or the pop-up window is not obtained), the related operation of obtaining the related data about the user ends, that is, the related data about the user is not obtained. In other words, all user data collected in this application is collected with user consent and authorization, and collection, use, and processing of related user data need to comply with related laws, regulations, and standards of related countries and regions.

FIG. 9 is a block diagram of a structure of a picture rendering apparatus according to an exemplary embodiment of this application. As shown in FIG. 9, the apparatusincludes:
a change determining module 901, configured to determine, according to an interaction instruction in an interaction process, a first rendering object that is changed in an (i+1)^{th}frame of interaction picture compared with an i^{th}frame of interaction picture and object changed content corresponding to the first rendering object, where i is a positiveinteger;
a layer rendering module 902, configured to render, based on the object changed content, a first object layer corresponding to the first rendering object, where the first object layer is obtained through division based on the corresponding first rendering object in a plurality of rendering objects in the interaction process; and
a layer overlaying module 903, configured to perform overlaying processing on the first object layer and a second object layer, to obtain the (i+1)^{th}frame of interaction picture, where the second object layer is an object layer corresponding to a second rendering object that is not changed between the (i+1)^{th}frame of interaction picture and the i^{th}frame of interaction picture.

In some embodiments, the layer rendering module 902 is further configured to: determine a layer rendering manner based on the object changed content, where the layer rendering manner includes at least one of layer re-rendering and layer parameter adjustment; and render, in the layer rendering manner, the first object layer corresponding to the first rendering object.

In some embodiments, the layer rendering module 902 is further configured to: when the object changed content indicates that a display status of the first rendering object is changed, determine that the layer rendering manner is the layer re-rendering, where the display status includes at least one of display content and a display form; when the object changed content indicates that a display position of the first rendering object is changed, determine that the layer rendering manner is layer coordinate adjustment; or when the object changed content indicates that a picture perspective is changed, determine that the layer rendering manner is at least one of layer coordinate adjustment and layer size adjustment.

In some embodiments, the layer overlaying module 903 is further configured to: determine layer transparency and layer display orders that are of the first object layer and the second object layer; perform transparency adjustment on the first object layer and the second object layer based on the layer transparency; and perform, based on the layer display orders, overlaying processing on a first object layer and a second object layer that are obtained through the transparency adjustment, to obtain the (i+1)^{th}frame of interaction picture.

In some embodiments, the layer overlaying module 903 is further configured to: determine the layer transparency of the first object layer and the second object layer according to the interaction instruction; and determine a first layer display order of the first object layer according to the interaction instruction, and determine a second layer display order of the second object layer according to the i^{th}frame of interaction picture.

In some embodiments, the apparatus further includes an object disassembling module, configured to disassemble, based on a displayed object affected by the interaction instruction, the displayed object that needs to be displayed in the interaction process, to obtain the plurality of rendering objects; and a layer division module, configured to perform, based on the plurality of rendering objects, layer division on an interaction picture related to the interaction process, to obtain a plurality of object layers.

In some embodiments, the layer division module is further configured to: perform the layer division on the interaction picture based on each rendering object, to obtain an object layer corresponding to the rendering object; or classify the plurality of rendering objects to obtain rendering objects belonging to different object types, and perform the layer division on the interaction picture based on the different object types, to obtain object layers corresponding to the different object types.

In some embodiments, the different object types include a background object type, a character object type, and a control object type. The layer division module is further configured to perform the layer division on the interaction picture based on the different object types, to obtain a background object layer, a character object layer, and a control object layer.

In some embodiments, the layer division module is further configured to: divide the background object layer to obtain a static background sub-layer and a dynamic background sub-layer; divide the character object layer to obtain a user character sub-layer and a non-user character sub-layer; and divide the control object layer to obtain an action control sub-layer and a prompt control sub-layer.

In some embodiments, the apparatus further includes a picture rendering module, configured to: when the interaction instruction is a specified interaction instruction, perform overall picture rendering on the (i+1)^{th}frame of interaction picture, where a picture change amplitude instructed by the specified interaction instruction is greater than a picture change amplitude instructed by another interaction instruction.

In some embodiments, the apparatus further includes a layer storage module, configured to: delete a third object layer corresponding to a third rendering object in the i^{th}frame of interaction picture compared with the (i+1)^{th}frame of interaction picture, and store the third object layer in a cache, where the third rendering object includes a rendering object that is no longer displayed in the (i+1)^{th} frame of interaction picture compared with the i^{th} frame of interaction picture; and a layer searching module, configured to: when a newly added fourth rendering object exists in the (i+1)^{th}frame of interaction picture compared with the i^{th}frame of interaction picture, search the cache for a fourth object layer corresponding to the fourth rendering object.

In some embodiments, the apparatus further includes a layer removing module, configured to: when caching duration of the third object layer reaches a caching time limit, remove the third object layer from the cache.

In some embodiments, the apparatus further includes a processing module, configured to: input first description information, second description information, third description information, and guidance information into a large language model, to obtain a reserved computing resource predicted by the large language model; and amplify the reserved computing resource, and perform resource reservation on an amplified reserved computing resource, where the amplified reserved computing resource is configured for rendering the first object layer corresponding to the first rendering object, the first description information is configured for describing a computing resource of the computer device, the second description information is configured for describing the first rendering object, the third description information is configured for describing the object changed content, and the guidance information is configured for guiding the large language model to predict a computing resource consumed, when the object changed content is generated, in the computing resource of the computer device to render the first rendering object.

The apparatus provided in the foregoing embodiments is only described in an example of division of the foregoing functional modules, and in actual application, the foregoing functions may be implemented by different functional modules as required, that is, an internal structure of the apparatus is divided into different functional modules, to implement all or some of the functions described above. In addition, the apparatus provided in the foregoing embodiments and the method embodiments fall within a same conception. For details of an implementation process, refer to the method embodiments. Details are not described herein again.

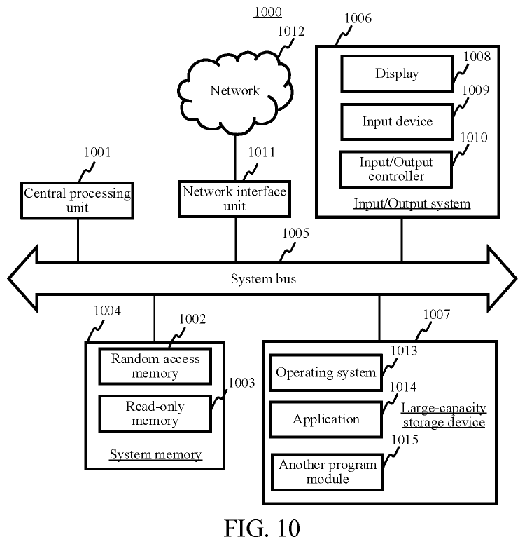

FIG. 10 is a schematic diagram of a structure of a computer device according to an exemplary embodiment of this application. Specifically, the computer device 1000 includes a central processing unit (CPU) 1001, a system memory 1004 including a random access memory 1002 and a read-only memory 1003, and a system bus 1005 connecting the system memory 1004 and the central processing unit 1001. The computer device 1000 further includes a basic input/output system (I/O system) 1006 configured to help information transmission between components in a computer, and a large-capacity storage device 1007 configured to store an operating system 1013, an application 1014, and another program module 1015.

In some embodiments, the basic input/output system 1006 includes a display 1008 configured to display information, and an input device 1009 configured to input information by a user, such as a mouse and a keyboard. The display 1008 and the input device 1009 are both connected to the central processing unit 1001 via an input and output controller 1010 connected to the system bus 1005. The basic input/output system 1006 may further include the input and output controller 1010, for receiving and processing an input from a plurality of other devices such as a keyboard, a mouse, or an electronic stylus. Similarly, the input/output controller 1010 further provides an output to a display screen, a printer, or another type of output device.

The large-capacity storage device 1007 is connected to the central processing unit 1001 via a large-capacity storage controller (not shown) connected to the system bus 1005. The large-capacity storage device 1007 and an associated computer-readable medium provide non-volatile storage for the computer device 1000. In other words, the large-capacity storage device 1007 may include a computer-readable medium (not shown) such as a hard disk or a drive.

Without loss of generality, the computer-readable medium may include a computer storage medium and a communication medium. The computer storage medium includes volatile and non-volatile, and removable and non-removable media that store information such as computer-readable instructions, data structures, program modules, or other data and that are implemented by using any method or technology. The computer storage medium includes a random access memory (RAM), a read-only memory (ROM), a flash memory or another solid-state storage technology, a compact disc read-only Memory (CD-ROM), a digital versatile disc (DVD) or another optical memory, a magnetic cassette, a magnetic tape, a magnetic disk memory, or another magnetic storage device. It is clear that, it may be known by a person skilled in the art that the computer storage medium is not limited to the foregoing several types. The system memory 1004 and the large-capacity storage device 1007 may be collectively referred to as a memory.

The memory stores one or more programs. The one or more programs are configured to be executed by one or more central processing units 1001. The one or more programs include instructions for implementing the foregoing methods. The central processing unit 1001 executes the one or more programs to implement the methods provided in the foregoing method embodiments.

According to the embodiments of this application, the computer device 1000 may further be connected, through a network such as the Internet, to a remote computer on the network. In other words, the computer device 1000 may be connected to a network 1012 via a network interface unit 1011 connected to the system bus 1005, or may be connected to another type of network or a remote computer system (not shown) via a network interface unit 1011.

The memory further includes one or more programs, where the one or more programs are stored in the memory, and include operations that are configured for performing the method provided in the embodiments of this application and that are performed by the computer device.

An embodiment of this application further provides a non-transitory computer-readable storage medium. The computer-readable storage medium stores at least one instruction, at least one program, and a code set or an instruction set. The at least one instruction, the at least one program, and the code set or the instruction set are loaded and executed by a processor to implement the picture rendering method according to any one of the foregoing embodiments.

An embodiment of this application provides a computer program product or a computer program. The computer program product or the computer program includes computer instructions. The computer instructions are stored in a computer-readable storage medium. A processor of a computer device reads the computer instructions from the computer-readable storage medium, and executes the computer instructions, to cause the computer device to perform the picture rendering method according to the foregoing aspect.

A person of ordinary skill in the art may understand that all or some of the operations in the various methods in the foregoing embodiments may be implemented by a program instructing relevant hardware. The program may be stored in a computer-readable storage medium. The computer-readable storage medium may be a computer-readable storage medium included in the memory in the foregoing embodiments, or may be a computer-readable storage medium that exists alone and is not configured in a terminal. The computer-readable storage medium stores at least one instruction, at least one program, and a code set or an instruction set. The at least one instruction, the at least one program, and the code set or the instruction set are loaded and executed by the processor to implement the picture rendering method in any one of the foregoing method embodiments.

In some embodiments, the computer-readable storage medium may include: a ROM, a RAM, a solid state drive (SSD), an optical disc, or the like. The RAM may include a resistance random access memory (ReRAM) and a dynamic random access memory (DRAM). The sequence numbers of the foregoing embodiments of this application are merely for illustrative purposes, and are not intended to indicate priorities of the embodiments.

A person of ordinary skill in the art may understand that all or some of the operations of the embodiments may be implemented by hardware or a program instructing relevant hardware. The program may be stored in a computer-readable storage medium. The storage medium may be a read-only memory, a magnetic disk, an optical disc, or the like.

The foregoing descriptions are merely embodiments of this application, but are not intended to limit this application. Any modification, equivalent replacement, or improvement made within the spirit and principle of this application shall fall within the protection scope of this application.

What is claimed is:

1. A picture rendering method performed by a computer device, the method comprising:
determining object changed content of a first rendering object from an i^{th}frame of interaction picture to an (i+1)^{th}frame of interaction picture in response to an interaction instruction by a user of the computer device, i being a positive integer;
rendering, based on the object changed content, a first object layer corresponding to the first rendering object; and
performing overlaying processing on the first object layer and a second object layer, to obtain the (i+1)^{th}frame of interaction picture, the second object layer being an object layer corresponding to a second rendering object that is not changed between the (i+1)^{th}frame of interaction picture and the i^{th}frame of interaction picture.

2. The method according to claim 1, wherein the rendering, based on the object changed content, a first object layer corresponding to the first rendering object comprises:
determining a layer rendering manner based on the object changed content; and
rendering, in the layer rendering manner, the first object layer corresponding to the first rendering object.

3. The method according to claim 2, wherein the determining a layer rendering manner based on the object changed content comprises:
when the object changed content indicates that a display status of the first rendering object is changed, determining that the layer rendering manner is a layer re-rendering;
when the object changed content indicates that a display position of the first rendering object is changed, determining that the layer rendering manner is layer coordinate adjustment; and
when the object changed content indicates that a picture perspective is changed, determining that the layer rendering manner is at least one of layer coordinate adjustment and layer size adjustment.

4. The method according to claim 1, wherein the performing overlaying processing on the first object layer and a second object layer, to obtain the (i+1)^{th}frame of interaction picture comprises:
determining layer transparency and layer display orders of the first object layer and the second object layer;
performing transparency adjustment on the first object layer and the second object layer based on the layer transparency; and
performing, based on the layer display orders, overlaying processing on a first object layer and a second object layer that are obtained through the transparency adjustment, to obtain the (i+1)^{th}frame of interaction picture.

5. The method according to claim 1, wherein the method further comprises:
disassembling a displayed object affected by the interaction instruction into a plurality of rendering objects including the first rendering object; and
performing layer division on an interaction picture related to the interaction process based on the plurality of rendering objects to obtain a plurality of object layers including the first object layer and the second object layer.

6. The method according to claim 1, wherein the method further comprises:
performing overall picture rendering on the (i+1)^{th}frame of interaction picture when a picture change amplitude based on the object changed content instructed by the interaction instruction is greater than a picture change amplitude instructed by another interactioninstruction.

7. The method according to claim 1, wherein the method further comprises:
deleting a third object layer corresponding to a third rendering object displayed in the i^{th}frame of interaction picture and not displayed in the (i+1)^{th}frame of interaction picture; and
when a newly added fourth rendering object exists in the (i+1)^{th}frame of interaction picture but not in the i^{th}frame of interaction picture, searching a cache for a fourth object layer corresponding to the fourth rendering object.

8. The method according to claim 1, wherein the method further comprises:
inputting first description information, second description information, third description information, and guidance information into a large language model, to obtain a reserved computing resource predicted by the large language model for rendering the first object layer corresponding to the first rendering object; and
amplifying the reserved computing resource, and performing resource reservation on the amplified reserved computing resource.

9. A computer device comprising a processor and a memory, the memory storing at least one program, and the at least one program, when executed by the processor, causing the computer device to implement a picture rendering method including:
determining object changed content of a first rendering object from an i^{th}frame of interaction picture to an (i+1)^{th}frame of interaction picture in response to an interaction instruction by a user of the computer device, i being a positive integer;
rendering, based on the object changed content, a first object layer corresponding to the first rendering object; and
performing overlaying processing on the first object layer and a second object layer, to obtain the (i+1)^{th}frame of interaction picture, the second object layer being an object layer corresponding to a second rendering object that is not changed between the (i+1)^{th}frame of interaction picture and the i^{th}frame of interaction picture.

10. The computer device according to claim 9, wherein the rendering, based on the object changed content, a first object layer corresponding to the first rendering object comprises:
determining a layer rendering manner based on the object changed content; and
rendering, in the layer rendering manner, the first object layer corresponding to the first rendering object.

11. The computer device according to claim 10, wherein the determining a layer rendering manner based on the object changed content comprises:
when the object changed content indicates that a display status of the first rendering object is changed, determining that the layer rendering manner is a layer re-rendering;
when the object changed content indicates that a display position of the first rendering object is changed, determining that the layer rendering manner is layer coordinate adjustment; and
when the object changed content indicates that a picture perspective is changed, determining that the layer rendering manner is at least one of layer coordinate adjustment and layer size adjustment.

12. The computer device according to claim 9, wherein the performing overlaying processing on the first object layer and a second object layer, to obtain the (i+1)^{th}frame of interaction picture comprises:
determining layer transparency and layer display orders of the first object layer and the second object layer;
performing transparency adjustment on the first object layer and the second object layer based on the layer transparency; and
performing, based on the layer display orders, overlaying processing on a first object layer and a second object layer that are obtained through the transparency adjustment, to obtain the (i+1)^{th}frame of interaction picture.

13. The computer device according to claim 9, wherein the method further comprises:
disassembling a displayed object affected by the interaction instruction into a plurality of rendering objects including the first rendering object; and
performing layer division on an interaction picture related to the interaction process based on the plurality of rendering objects to obtain a plurality of object layers including the first object layer and the second object layer.

14. The computer device according to claim 9, wherein the method further comprises:
performing overall picture rendering on the (i+1)^{th}frame of interaction picture when a picture change amplitude based on the object changed content instructed by the interaction instruction is greater than a picture change amplitude instructed by another interactioninstruction.

15. The computer device according to claim 9, wherein the method further comprises:
deleting a third object layer corresponding to a third rendering object displayed in the i^{th} frame of interaction picture and not displayed in the (i+1)^{th} frame of interaction picture; and
when a newly added fourth rendering object exists in the (i+1)^{th}frame of interaction picture but not in the i^{th} frame of interaction picture, searching a cache for a fourth object layer corresponding to the fourth rendering object.

16. The computer device according to claim 9, wherein the method further comprises:
inputting first description information, second description information, third description information, and guidance information into a large language model, to obtain a reserved computing resource predicted by the large language model for rendering the first object layer corresponding to the first rendering object; and
amplifying the reserved computing resource, and performing resource reservation on the amplified reserved computing resource.

17. A non-transitory computer-readable storage medium storing at least one program therein, the at least one program, when executed by a processor of a computer device, causing the computer device to implement a picture rendering method including:
determining object changed content of a first rendering object from an i^{th}frame of interaction picture to an (i+1)^{th}frame of interaction picture in response to an interaction instruction by a user of the computer device, i being a positive integer;
rendering, based on the object changed content, a first object layer corresponding to the first rendering object; and
performing overlaying processing on the first object layer and a second object layer, to obtain the (i+1)^{th}frame of interaction picture, the second object layer being an object layer corresponding to a second rendering object that is not changed between the (i+1)^{th}frame of interaction picture and the i^{th}frame of interaction picture.

18. The non-transitory computer-readable storage medium according to claim 17, wherein the performing overlaying processing on the first object layer and a second object layer, to obtain the (i+1)^{th}frame of interaction picture comprises:
determining layer transparency and layer display orders of the first object layer and the second object layer;
performing transparency adjustment on the first object layer and the second object layer based on the layer transparency; and
performing, based on the layer display orders, overlaying processing on a first object layer and a second object layer that are obtained through the transparency adjustment, to obtain the (i+1)^{th} frame of interaction picture.

19. The non-transitory computer-readable storage medium according to claim 17, wherein the method further comprises:
disassembling a displayed object affected by the interaction instruction into a plurality of rendering objects including the first rendering object; and
performing layer division on an interaction picture related to the interaction process based on the plurality of rendering objects to obtain a plurality of object layers including the first object layer and the second object layer.

20. The non-transitory computer-readable storage medium according to claim 17, wherein the method further comprises:
deleting a third object layer corresponding to a third rendering object displayed in the i^{th}frame of interaction picture and not displayed in the (i+1)^{th}frame of interaction picture; and
when a newly added fourth rendering object exists in the (i+1)^{th}frame of interaction picture but not in the i^{th}frame of interaction picture, searching a cache for a fourth object layer corresponding to the fourth rendering object.
